(19) United States
(12) Patent Application Publication
(10) Pub. No.: US 2011/0238903 A1
(43) Pub. Date: Sep. 29, 2011

(54) METHOD AND DEVICE OF MANAGING A REDUCED WEAR MEMORY

(76) Inventor: Amir Ban, Ramat-HaSharon (IL)

(21) Appl. No.: 13/132,937

(22) PCT Filed: Dec. 9, 2009
(86) PCT No.: PCT/IL2009/001164

§ 371 Date: Jun. 6, 2011

Related U.S. Application Data
(60) Provisional application No. 61/121,198, filed on Dec. 10, 2008.

(51) Int. Cl. G06F 12/02

(52) U.S. Cl. 711/103; 711/E12.008

(57) ABSTRACT

A method of encoding and storing data. The method comprises providing digital data designated to be written in at least one memory element having a plurality of memory cells, encoding digital data so as to increase the prevalence of at least one memory cell state in relation to the prevalence of at least one other memory cell state by conditionally inverting the data bits in accordance with the count of a particular state in the data to be written, and programming the plurality of memory cells to store the encoded digital data.

### RELATED APPLICATION/S

This application claims priority from U.S. Provisional Patent Application No. 61/121,198 filed on Dec. 10, 2008. The content of the above document is incorporated by reference as if fully set forth herein.

### FIELD AND BACKGROUND OF THE INVENTION

The present invention, in some embodiments thereof, relates to method and device of managing a reduced wear memory and, more particularly, but not exclusively, to method and device of managing write and read operation in a manner that prolongs the service life of some kinds of erasable computer storage media, such as flash memory.

During the last year the usage of flash memory increases as the demand for mobile electronic devices, such as digital cameras, portable digital assistants, portable audio/video players and mobile terminals continue to require mass storage memory, preferably non-volatile memory, with ever increasing capacities and speed capabilities. Flash memory, also known as solid-state drive, is popular because of their high density, non-volatility, and small size relative to hard disk drives. Flash memory comprises a memory array, which includes a large number of memory cells arranged in row and column fashion. Each of the memory cells includes a floating gate field-effect transistor capable of holding charges. The memory cells are usually grouped into blocks. Each of the cells within a block can be electrically programmed in a random basis by charging the floating gate. The charges can be removed from the floating gate by a block erasure operation, as outlined below. The presence or absence of the charges in the floating gate determines the data in a cell. Flash memory technology is based on erasable programmable read only memory (EPROM) and electrically EPROM (EEPROM) technologies. The term “flash” was chosen because a large number of memory cells could be erased at one time as distinguished from EEPROMs, where each byte is usually erased individually. Those of skill in the art will understand that Flash memory may be configured as NOR, NAND or other Flash, with NAND Flash having higher density per given area due to a more compact memory array structure. For the purpose of further discussion, references to flash memory should be understood as being any type Flash memory.

Non-volatile memory, such as flash memory have individually erasable segments, each of which can be put through a limited number of erase cycles before becoming unreliable. For example, the limited number of erase cycles of a single level cell (SLC) is around 100,000 and of a multi level cell (MLC) is around 10,000 cycles.

One of the methods that attempts to work around the limited number of erase cycles is wear leveling. These methods define a process in which the stored data is rearranged so that erasures and re-writes are distributed evenly across the medium. In this way, no single erase block prematurely fails due to a high concentration of write cycles. In flash memory, one block is usually longer life than the others so that the wear leveling controller can store operational data with less chance of its corruption.

Examples for such wear leveling techniques are described in U.S. Pat. No. 6,850,443, filed on May 2, 2003 that describes a mass storage system made of flash EEPROM cells organized into blocks, the blocks in turn being grouped into memory banks, is managed to even out the numbers of erase and rewrite cycles experienced by the memory banks in order to extend the service lifetime of the memory system. Since this type of memory cell becomes unusable after a finite number of erase and rewrite cycles, although in the tens of thousands of cycles, uneven use of the memory banks is avoided so that the entire memory does not become inoperative because one of its banks has reached its end of life while others of the banks are little used. Relative use of the memory banks is monitored and, in response to detection of uneven use, have their physical addresses periodically swapped for each other in order to even out their use over the lifetime of the memory. Another example is described in U.S. Pat. No. 7,552,272, filed on Oct. 10, 2006 that describes methods and apparatus for performing wear leveling in a non-volatile memory system are disclosed. Included is a method for performing wear leveling in a memory system that includes a first zone, which has a first memory element that includes contents, and a second zone includes identifying the first memory element and associating the contents of the first memory element with the second zone while disassociating the contents of the first memory element from the first zone. In one embodiment, associating the contents of the first memory element with the second involves moving contents of a second memory element into a third memory element, then copying the contents of the first memory element into the second memory element.

### SUMMARY OF THE INVENTION

According to some embodiments of the present invention there is provided a method of encoding and storing data. The method comprises providing digital data designated to be written in at least one memory element having a plurality of memory cells, encoding digital data so as to increase the prevalence of at least one memory cell state in relation to the prevalence of at least one other memory cell state, and programming the plurality of memory cells to store the encoded digital data.

Optionally, the encoding increases the prevalence of the at least one memory cell state in relation to the prevalence of at least one other memory cell state in at least 25%.

Optionally, the encoding comprises calculating a wear factor induced from storing each of a plurality of data units of at least one segment of the digital data in the at least one memory element and encoding the at least one segment according to the wear factor.

More optionally, the calculating comprises calculating the wear factor by weighting at least one memory cell state in the respective data unit according to the voltage threshold level (Vt) used by the plurality of memory cells for the representation thereof.

Optionally, further comprising computing a translation scheme according to an analysis of the digital data, the encoding being performed according to the translation scheme, the programming comprises programming the at least one memory element to store the translation scheme.

More optionally, the programming comprises programming the at least one memory element to store at least a portion of the translation scheme in out of band bytes (OOB) of its pages.

More optionally, the translation scheme comprises a translation list having a plurality of values of a plurality of data units in the digital data, each data unit being assigned with an coded string according to the prevalence thereof in at least at least one segment of the digital data.

More optionally, the translation scheme is compressed according to the order of the plurality of values, the order being set according to the frequency of the plurality of values in the digital data.

Optionally, the programming requires more memory space than programming the plurality of memory cells to store the digital data.

Optionally, the method further comprises segmenting the digital data to create a plurality of segments, the encoding comprising separately encoding each segment so as to increase the prevalence of at least one memory cell state in relation to the prevalence of at least one other memory cell state in a respective the segment.

More optionally, each segment is a k-bit string, the encoding being performed by using m-bit strings to encode the plurality of segments, where m>k and the m-bit strings being the 2 k m-bit strings with least wear factor.

More optionally, the memory cell states are binary states, the encoding comprises inverting the binary value of each segment if the prevalence of the at least one other memory cell state being higher than the prevalence of the at least one memory cell state in the respective segment.

Optionally, the method further comprises compressing the digital data before the encoding.

According to some embodiments of the present invention there is provided a memory device. The memory device comprises at least one memory element having a plurality of erasable and re-programmable non-volatile memory cells, an input interface which receives digital data from a host, a wear reduction coder which encodes the digital data so as to increase the prevalence of at least one memory cell state in relation to the prevalence of at least one other memory cell state, and a memory controller which programs the plurality of memory cells to store the encoded data.

Optionally, the memory controller segments the digital data to a plurality of segments and the wear reduction coder encodes each segment so as to increase the prevalence of the at least one memory cell state in relation to the prevalence of the at least one other memory cell state, the memory controller programs the plurality of memory cells to store the plurality of encoded segments.

Optionally, the at least one memory cell state is the memory cell state ‘1’ and the at least one other memory cell state being the memory cell state ‘0’.

Optionally, the wear reduction coder creates translation scheme, the wear reduction coder encodes the digital data according to the translation scheme.

Optionally, the at least one memory element includes an multi level cell (MLC) memory element, the wear reduction coder encodes the digital data so as to increase the prevalence of a plurality of memory cell states in relation to the prevalence of a plurality of other memory cell states.

More optionally, at least some of the plurality of the other memory cell states is represented by at least one first voltage threshold level (Vt) at the volatile memory cells and at least some of the plurality of the memory cell states being represented by at least one second Vt at the volatile memory cells, the at least one first Vt being higher than the at least one second Vt.

Optionally, the size of each encoded segment is larger than the size of a page of the at least one memory element.

Optionally, the size of each encoded segment is smaller than the size of a page of the at least one memory element.

Optionally, the at least one memory element comprises a flash memory.

According to some embodiments of the present invention, there is provided a system of storing encoded data. The system comprises a host which provides digital data for storage, a wear reduction coder which encodes the digital data so as to increase the prevalence of at least one memory cell state in relation to the prevalence of at least one other memory cell state plurality in the digital data, and a memory device having at least one memory element with a plurality of erasable and re-programmable non-volatile memory cells and a memory controller which programs the plurality of memory cells to store the encoded data.

Optionally, the wear reduction coder is hosted by the host.

Optionally, the wear reduction coder is a firmware module integrated the memory controller.

According to some embodiments of the present invention, there is provided a method of decoding stored data. The method comprises providing request for digital data stored in at least one memory element having a plurality of memory cells, identifying a translation scheme for decoding at least one segment of the digital data in the at least one memory element, decoding digital data using the translation scheme, and retrieving the decoded digital data. The decoding increases the prevalence of at least one memory cell state in relation to the prevalence of at least one other memory cell state in the at least one segment.

According to some embodiments of the present invention, there is provided a method of encoding and storing data. The method comprises providing digital data designated to be written in at least one memory element having a plurality of memory cells, encoding digital data so as to reduce the prevalence of at least one memory cell state, and programming the plurality of memory cells to store the encoded digital data. The size of the encoded digital data is not smaller than the size of the digital data. Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of a host connected to a memory device having means for increasing the prevalence of one or more memory cell states in relation to one or more other memory cell states in data designated to be written in a memory element, according to some embodiments of the present invention;

FIG. 1B is another schematic illustration of the host and the flash memory device, according to some embodiments of the present invention;

FIG. 1C is a schematic illustration of an exemplary host that interfaces with an exemplary flash memory device, according to some embodiments of the present invention;

FIG. 2 is a flowchart of a method of increasing the prevalence of one or more memory cell states in relation to one or more other memory cell states in data designated to be written in a memory element, according to some embodiments of the present invention;

FIG. 3 is a schematic illustration of another exemplary host connected to the exemplary memory device where the host has means for increasing the prevalence of one or more memory cell states in relation to one or more other memory cell states in data designated to be written in a memory element, according to some embodiments of the present invention;

FIG. 4 is a flowchart of an exemplary process for encoding input data according to the prevalence of data unit values, according to some embodiments of the present invention;

FIG. 5 is a flowchart for decoding the data encoded according to a translation scheme, according to some embodiments of the present invention;

FIGS. 6A, 7, 8 and 10 are exemplary tables that depict various translation schemes, according to some embodiments of the present invention;

FIG. 6B depicts an exemplary inverse index table which is based on the exemplary table depicted in FIG. 6A, according to some embodiments of the present invention;

FIG. 9 depicts an exemplary table that assigns different wear factors to different memory cell states, proportionally to the estimated wear they induce; and

FIG. 11 is a table that exhibits the result of six encoding processes set according to some embodiments of the present invention.

### DESCRIPTION OF EMBODIMENTS OF THE INVENTION

The present invention, in some embodiments thereof, relates to method and device of managing a reduced wear memory and, more particularly, but not exclusively, to method and device of managing write and read operation in a manner that prolongs the service life of some kinds of erasable computer storage media, such as flash memory.

According to some embodiments of the present invention, there is provided method and memory device of encoding data designated to be stored on one or more memory elements having erasable and re-programmable non-volatile memory cells, such as flash memory elements, in a manner that increase the prevalence of one or more memory cell states in relation to the prevalence of one or more other memory cell states. In another example, the prevalence of memory cell states with high voltage threshold levels in the one or more memory elements is reduced in relation to the prevalence of memory cell states with low voltage threshold levels.

Optionally, the memory elements include one or more SLC and/or MLC memory elements.

In use, the memory device is connected, in a fixed or a detachable manner, to one or more hosts, referred to herein as a host. The memory device optionally has a wear reduction coder that generates one or more translation schemes for one or more segments of the input data and uses each translation scheme for encoding a respective segment. The one or more memory elements are programmed to store the translation schemes with the decoded segments.

The translation scheme is generated by an analysis of the input data, optionally an analysis of the frequency of different data unit values, such as byte values, word values and the like. The analysis optionally includes assigning each data unit value with an coded string so that the higher is the frequency of a certain data unit value the lower is the prevalence of one or more selected memory cell states in the coded string associated therewith. Using the translation scheme to encode the input data reduces the sum of selected memory cell states, such as ‘0’, and therefore the wear induced from storing the encoded data in relation to the original data is reduced.

According to some embodiments of the present invention, the encoding which is outlined above and described below is performed by a wear reduction coder that is installed in the controller of a memory device or as a separate component that is placed between the controller and the interface of device with a host. Alternatively, the encoding is performed by a wear reduction coder that is installed in a driver of a host that requests the writing of the input data in a memory device. Optionally, some components of the wear reduction coder are installed in the driver and others in the controller.

Additionally or alternatively to reducing the wear of one or more memory elements, the encoding process that is outlined above and described below may be used to reduce the power consumption and/or the write-disturb fault (WDF) of the memory device and/or to increase the data retention of the memory device and/or to decrease the cross-charge effects of the memory device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

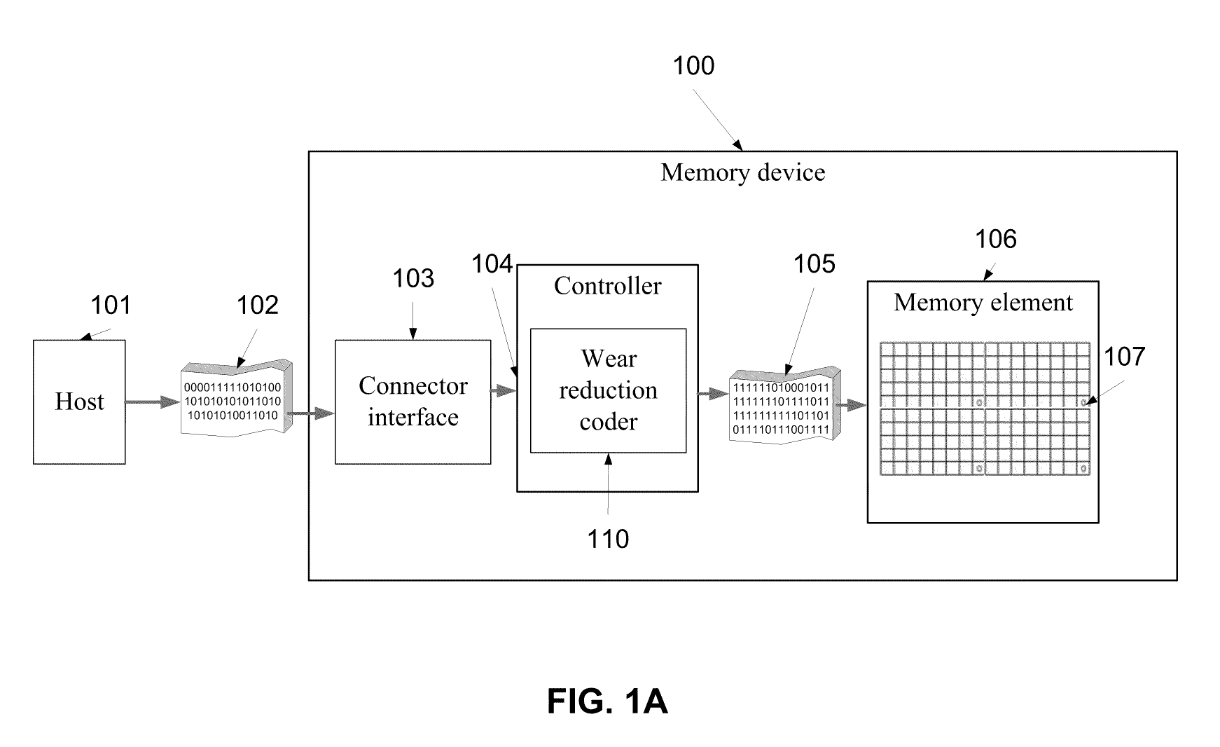

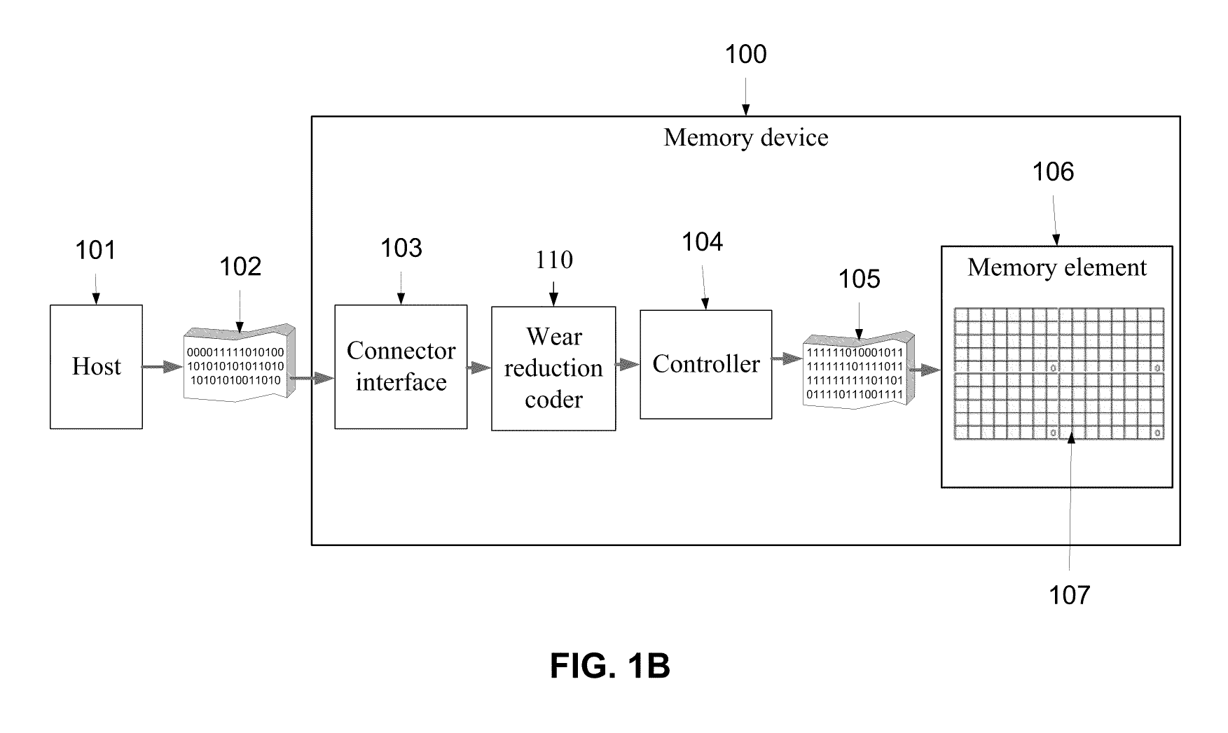

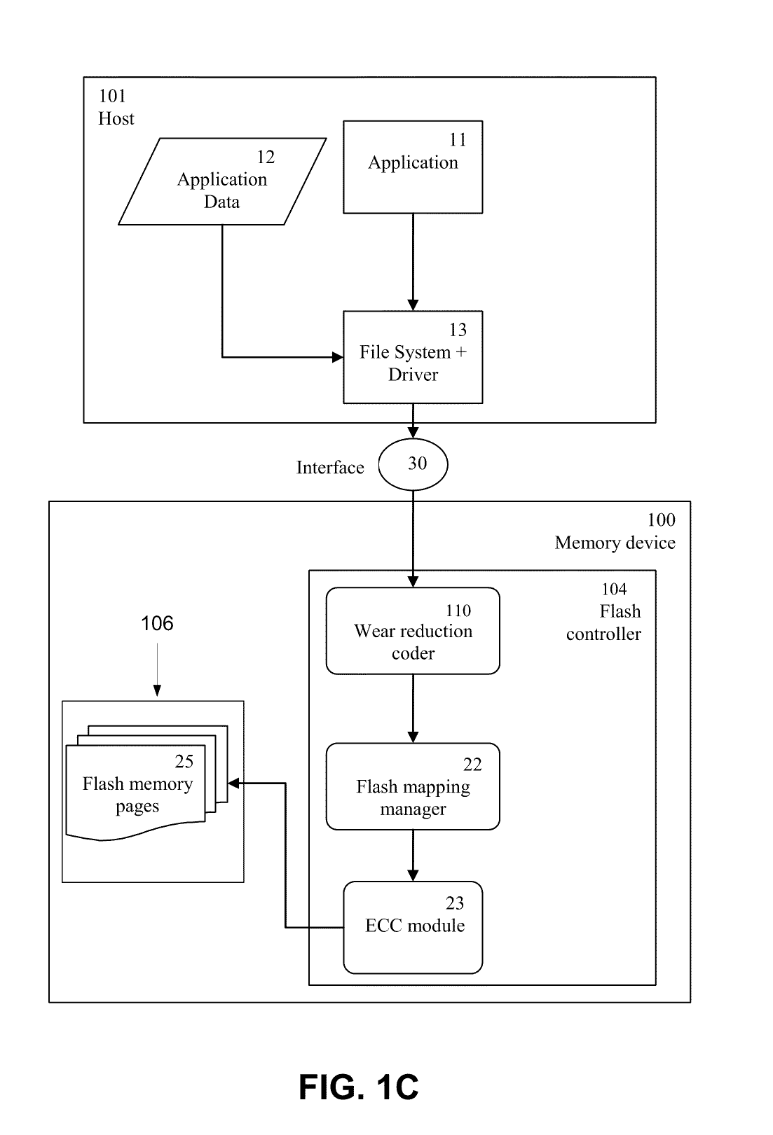

Reference is now made to FIG. 1A, which is a schematic illustration of an exemplary host connected to an exemplary memory device 100 having means for increasing the prevalence of one or more memory cell states in relation to one or more other memory cell states in data designated to be written in a memory element, according to some embodiments of the present invention.

As used herein, a memory cell state means a physical or logic state, such as a binary state, for example ‘1’ or ‘0’, a physical or logic state of a multi level state such as a level of a multi level memory cell, for example ‘00’, ‘01’, ‘10’ and ‘11’ in a four level memory cell and/or a respective physical state, for example a voltage threshold level representing the logic state ‘001’. As used herein, a host means a host computing system, for example a computing unit, such as a laptop, a computer, and/or any other device that forward access, write and/or read instruction to a memory device. As used herein, a memory device means a flash memory device, a portable flash drive, a memory card, such as CompactFlash™ (CF) card, Multimedia card (MMC), secure digital (SD) card, smart media card, personnel tags (P-Tag), and memory stick cards, a stationary flash drive, USB drive, a Flash EPROM, an EEPROM device, and/or any other device that uses non-volatile computer storage that can be electrically erased and reprogrammed.

The memory device 100 includes one or more memory elements 106, for brevity referred to herein as a memory element 106, each with a plurality of erasable and re-programmable non-volatile memory cells 107, for example a common flash memory unit made of polysilicon layers. The memory element 106 may be a single level cell (SLC) memory element that stores one bit value per cell where the bit value is interpreted as a “0” or a “1” or a multi level cell (MLC) memory element that stores multiple values per cell where the bit values may be interpreted as 2ⁿ distinct states, for example 00, 01, 10, or 11 when n=2 and 000, 001, 010, 011, 100, 101, 110, 111 when n=3.

The memory device 100 includes a connector interface 103 that optionally includes a physical connector and a logical interface and designed to establish a communication channel with the host 101. Optionally, the physical connector electrically connects the memory device 100 to the host 101, for example via a USB 2.0 connection, a printed circuit board (PCB) connection, a Firewire connection, a memory card socket and the like.

The memory device 100 includes a memory controller 104 that manages the access to the memory element 106. The memory controller 104 manages communication with the host 101 and programs the memory cells 107 to store and erase data. The memory controller 104 may have several components including a microprocessor, a buffer cache, such as a buffer random access memory (RAM) and a central processing unit (CPU) RAM. Both buffer RAM and CPU RAM may be static RAM (SRAM) memories. These components may be on the same chip or on separate chips. The microprocessor runs a firmware to carry out operations including transferring data to and from the memory array. The firmware contains several logical modules such as a flash mapping manager and an error correction code (ECC) module. Optionally, the firmware contains a wear reduction coder 110, for example as described below. The buffer cache may be used to hold data prior to writing to the memory array or prior to sending the data to the host 101. The memory controller 104 may be a single integrated circuit or consist of several integrated circuits. As further described below, the wear reduction coder 110 may be implemented in software which is executed by the host 101.

As outlined above, memory elements, such as the memory element 106, wears with use. Wear is brought about by the trapping of charges in the cell's dielectric, causing irreversible damage to characteristics of the memory cells 107, and ultimately causing program/erase errors and loss of data retention capability. While writing and erasing go hand-in-hand for flash memory, it is mostly the writing part of a write/erase cycle of a flash element that is responsible for the wear. During writing, the charge of one or more memory cells is changed. For example, in SLC memory element, the charge is changed to represent the memory cell state ‘0’ while charges of other memory cells remain as is, representing the memory cell state ‘1’. In each erasing cycle, one or more blocks of memory cells are erased by changing the charge of each one of them to represent the memory cell state ‘1’. Thus, memory cells which are left to represent the memory cell state ‘1’ and not the memory cell state ‘0’ experience less wear.

In some embodiments of the present invention, the wear reduction coder 110 reduces the wear of SLC memory elements. In such embodiments, the wear reduction coder 110 manages the writing operations, and optionally the reading operations, in a manner that increases the prevalence of the memory cell state ‘1’ in relation to the memory cell state ‘0’. In use, as further described below, the reduction module 110 encodes data designated to be stored in the memory element 106 as coded data in which the memory cell state ‘1’ is more prevalent than the memory cell state ‘0’. Optionally, the wear reduction coder 110 compresses the forwarded data to further reduce the total number of digits that represent the memory cell state ‘0’.

In some embodiments of the present invention the wear reduction coder 110 reduces the wear of other multi state memory elements, for example MLC memory elements. In such embodiments, the wear reduction coder 110 manages the writing operations, for example of data 102 received from the host 101 and optionally the reading operations, in a manner that increases the prevalence of one or more memory cell states in relation to other memory cell states which induce a higher wear reduction. In use, as further described below, the reduction module 110 encodes data designated to be stored in the memory element 106 as coded data in which the memory cell state ‘11’ or ‘111’ is more prevalent than the memory cell state ‘00’ or ‘000’. The controller 104 than programs the memory element 106 to store the encoded data 105 in the memory cells 107.

FIG. 1B depicts another schematic illustration of the host 101 and the flash memory device 100, according to some embodiments of the present invention. The host 101, the memory device 100 and controller 104 are as depicted in FIG. 1A. However, in FIG. 1B the wear reduction coder 110 is placed between the controller 104 and the interface 103. In such a embodiment, the controller 104 participate in the writing and/or reading process as known in the art and the reduction coder 110 encodes and/or decodes data as outlined above and further described below.

FIG. 1C depicts a schematic illustration of an exemplary host 101 that interfaces with an exemplary flash memory device, according to some embodiments of the present invention. The host 101, the memory device 100 and its wear reduction coder 110 and controller 104 are as depicted in FIG. 1A, however FIG. 1C further depicts additional components which participate in the writing and/or reading process.

The host 101 is connected to the flash memory device 100 via a physical connector and a logical interface 30. The memory element 106 of the flash memory device 100 includes a plurality of flash memory pages 25. The flash controller 104 contains the wear reduction module 104 and at least a flash mapping manager 22 and an ECC module 23. In an exemplary writing process, an application 11 executed on the host 101 submits application data 12 to a file system 13, which in turn utilizes a flash driver 13 to access the flash controller 104 across the interface 30. Now the wear reduction coder 21 calculates a translation scheme and uses it for encoding the input data. As further described below, the translation scheme may be computed and used separately for each segment of the input data. The encoded data and the translation scheme are forwarded to the flash mapping manager 22 that assigns one or more physical flash pages 25 which are programmed to store the encoded data. Optionally, before writing, the ECC module 23 attaches redundancy data to the data that enables data errors to be located and corrected. The data is then written to the flash pages 25, completing the write operation. To read data from the flash device 100 an application 11 issues a file system read request. The file system 13 instructs the flash device driver 12 to access the flash device controller 104 across the connector interface 30. The flash mapping module 22 locates one or more physical flash pages 25 according to the system read request. The data is read and processed by the ECC module 23, which identifies and corrects any errors in the data. Now data is decoded by the wear reduction module 21, according to the respective translation scheme, for example as described below. The decoded data is retrieved to the file system and driver 13, which places it in an application data area, completing the read operation.

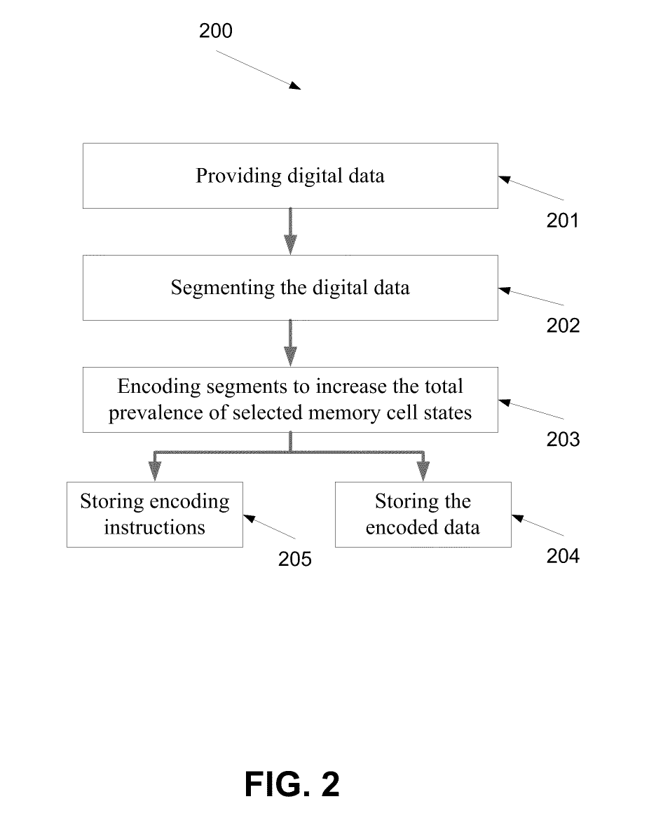

Reference is now also made to FIG. 2, which is a flowchart of a method 200 of increasing the prevalence of one or more memory cell states in relation to one or more other memory cell states in input data designated to be written in the memory element 106, according to some embodiments of the present invention.

In use, input data that designated to be written in the memory element 106 of the memory device is received 201. The received data may be received from an application and/or a file system executed on the host 101 or communicates therewith.

Then, as shown at 202, the received digital data is optionally segmented to a plurality of segments, which may be referred to herein as input data segments. Optionally, the segmentation is performed by the controller 104 and/or by the wear reduction coder 110. Optionally, the segmentation is executed and computed by the host 101, optionally by a device driver that handles the communication between the host 101 and the memory device 100. The segmentation may be performed according to known segmentation protocols and/or according to a data pertaining to the memory element 106 and/or the input data, for example as further described below.

Now, as shown at 203, the segments are encoded, simultaneously or sequentially, so as to increase the prevalence of one of the memory cell states in relation to one or more other memory cell states in some or all of the plurality of segments. In such a manner, the wear of the memory cells 107 of the memory element 106 is reduced. For example, in SLC memory elements, the prevalence of the memory cell state ‘1’ in relation to the memory cell state ‘0’ reduces the number of erasing operations in which the charge of the memory cell is reset from ‘0’ to ‘1’. As further described below, a similar encoding process is applied for reducing the wear of MLC memory elements.

Optionally, each input data segment is encoded as a coded segment. Optionally, the size of each encoded segment is a page size, which is usually the smallest individually writable area. For example, in a memory element 106, configured as a NAND flash, the encoded segment size is defined according to the NAND generations, presently between 4K (4096) bytes and 8K (8192) bytes.

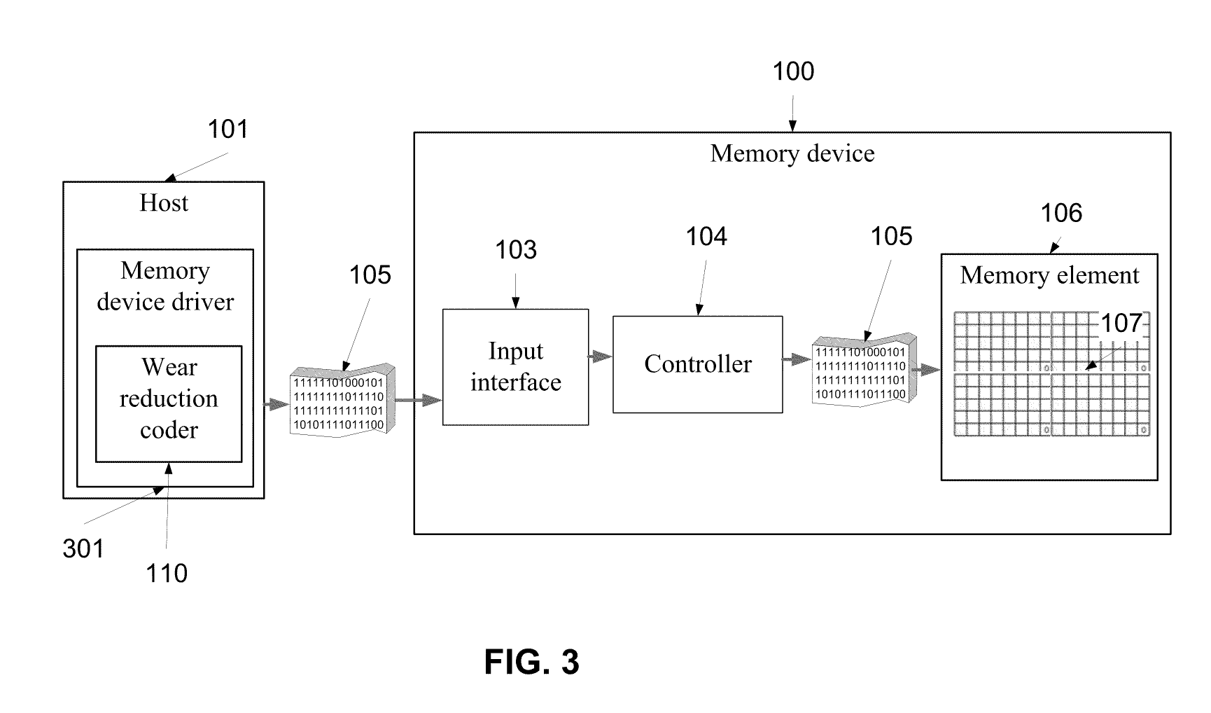

The encoding is performed by the wear reduction coder 110 that is installed in the memory device 100, for example as described above, and/or in the host 101 as depicted in FIG. 3 that depicts a schematic illustration of a host with a device driver 301 with the wear reduction coder 110. The device driver 301 uses the wear reduction coder 110 to encode data from the host to the memory device 100 and vice versa. In such an embodiment, the encoding and/or decoding may be performed at the host, before any data is forwarded for storage at the memory device 100 and/or after the encoded data is received from the storage.

Optionally, the encoding creates one or more encoded segments and a translation scheme, such as a translation table, that includes a translation scheme from each of a set of input binary arrays symbols to one of a set of output binary arrays. In use, the translation scheme may be used for decoding the encoded data. The translation scheme is optionally stored together with the encoded data. Optionally, each encoded segment is separately generated and associated with translation scheme for decoding it. For example, the wear reduction coder 110 may program the memory cells to store the translation scheme before, during and/or after the encoded segments is written thereinto. Optionally, some or all of the encoded segments are created and/or associated with a common translation scheme. In such a manner, the storage area required for storing the copies of the translation scheme is reduced.

Optionally, the data is compressed before being encoded. It should be noted that the process described herein is not similar to a data compression process. The size of the encoded data is usually larger than the size of the original data and the ratio between different memory cell states is intentionally changed regardless to a certain compression ratio. Though in some cases compression may reduce wear as it reduces the storage space, it does not take into account the ratio between different memory cell states. Compression may even increase the wear of the memory element 106 if the wear factor of the compressed data is higher than the wear factor of the original data.

A number of processes may be used for encoding the input segments in a manner that increases the prevalence of one or more the memory cell states in relation to one or more other memory cell states. For brevity, such encoding may be referred to herein as a process in which the wear factor of the data is reduced. In SLC memory elements, the wear factor of a segment is the sum of bits in the segment which are in unerased state, usually the sum of ‘0’ bits. In multi state memory elements, such as MLC memory elements, a wear factor is a sum of weighted values that represent different memory cell states. For example, the memory cell state ‘11’ may have the wear factor 0 and the memory cell state ‘00’ may have the wear factor 3.

According to some embodiments of the present invention, data units of the digital data, for example bytes, words, double words, quad words or any other data units are segmented and separately encoded. In such embodiments, each segment is data unit. The encoding of each segment is performed by inverting the values of each bit of the data unit if the wear factor of the data unit is higher than half of the number of bits of the data unit. For example, when the data unit is byte, the inverting is performed if the wear factor is 4 or less. The encoded segment is associated, optionally attached, with a translation bit that indicates if the bits of the encoded segment are inverted or not. In such a manner, if the translation bit is set as 1, the decoding includes creating a copy of encoded segment as the retrieved segment and if the translation bit is set as 0, the decoding is performed by inversing the value of each one of the bits. For example, hex EA (11101100) is coded as 111011001 and hex 10 (00010000) is coded as 111011110. In this example, each encoded segment has a maximum wear factor of 4 per 9 bits (equals to a maximum wear factor of 3.56 per byte) compared to the maximum wear factor of the received data which is 8 per byte. Such an encoding process increases the endurance of the memory element 106 by a factor of up to 2.25, albeit at a cost of additional 12.5% in the data's size. In such embodiments, the decoding is performed according to the translation bit. If the translation bit equals 1, the byte remains the same; else the byte is decoded by inverting the value of each one of its bits.

The embodiment described above in effect replaces 8-bit input words with 9-bit code words by 2⁸ 9-bit words with the lowest wear factor. In general terms, k-bit input words are replaced by m-bit words, where m is greater than k and 2^{k} m-bit words of least wear factor replace the code 2^{k} k-bit words.

According to some embodiments of the present invention, the encoding process is adjusted according to an analysis of the data designated to be written in the memory element 106.

Optionally, one or more input segments are encoded according to the prevalence of certain data unit values therein. Each input segment contains data units, such as bytes, words, double words, quad words or any other data units. Optionally, each data unit is translated according to its prevalence of its value in the input segment. Data units with the most prevalent value, for example a certain string, are translated to coded strings that have a value that induces no wear factor or the lowest wear factor and the input data units with the least prevalent value are translated to coded strings that have the value that induces the highest wear factor. Other data units are translated according to their proportional share in the input data. For example, if the input data unit is byte, the binary value 11111111 (hex FF) with the lowest wear factor 0 is used for encoding the most prevalent byte, and the second to ninth most common bytes are respectively encoded as a byte with the second lowest wear factor 1, namely hex 7F, BF, DF, EF, F7, FB, FD and FE, and so on and so forth. If all the byte values are present in the input data, the byte with the least common value is encoded as the byte with the highest wear factor value 00000000 (hex 00).

Optionally, the encoding replaces data unit values with k bits length with coded strings with m bits length where m≧k. Optionally, translation scheme is generated by creating a translation list. The 2^{k} possible data unit values are arranged in the order of their relative frequency in the data. Each member of the translation list is associated with a coded string. The data unit values are assigned, according to their prevalence, with m long bit strings having the lowest wear factor of 2^{m} possible. The more prevalent the data unit value in the translation list is, the smaller the wear factor of writing the coded string that is associated therewith will be.

When the frequency of a certain data unit value, with a certain wear factor, in input data units of the input segment is equal to the prevalence of one or more other data unit values with the same wear factor in these input data units, a tie-breaking rule may be adopted for determining their order in the list. Randomization may be used to avoid patterns.

As described above, the data unit values are assigned, according to their prevalence, with m long bit strings having the lowest possible wear factor of 2^{m} options. Optionally, the assignment is performed as follows:

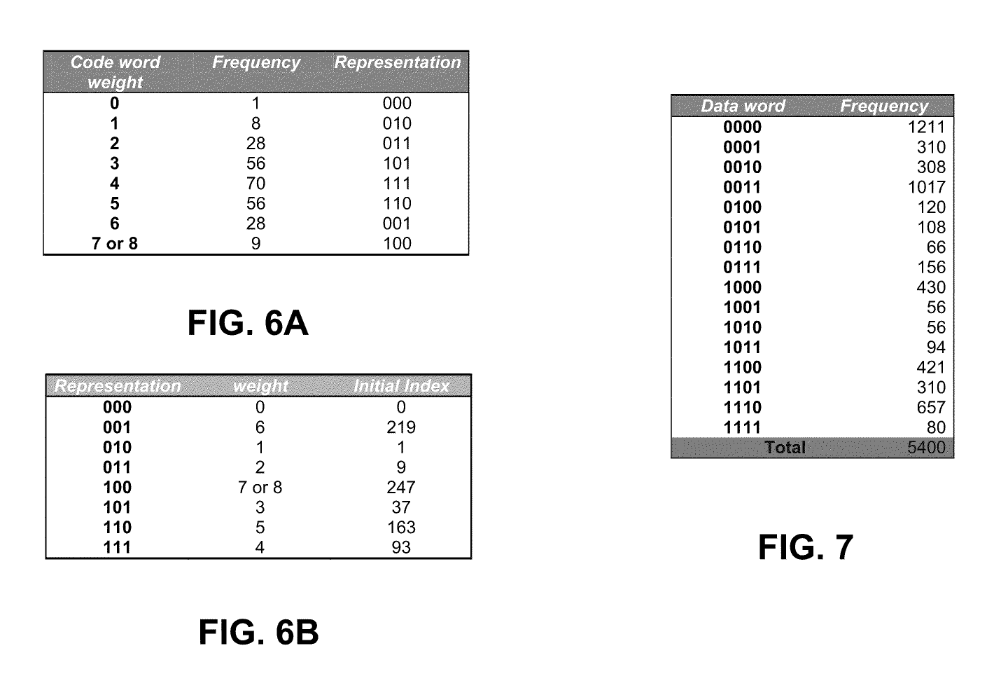

The 2^{k} possible data unit values are sorted according to their frequency in the segment. Then, data unit values are assigned to wear factor categories, such as wear factor categories where the highest frequency data unit value is assigned to the lowest-wear factor category. For example, see FIG. 6A where the most common data unit value is assigned to wear factor category 1, the next 8 most frequent data unit values are assigned to wear factor category 2, the next 28 most frequent data unit values are assigned to wear factor category 3, and so on and so forth.

The data unit values, which are assigned to a certain wear factor category, are ordered in an increasing lexicographic order. For example, according to the wear factor categories in FIG. 6B. For example, the data unit values (hex) 1C, 06, 88, 07, 14, 2A, 05 and 72 are assigned to wear factor category 2 and rearranged in the following ascending order: (hex) 05, 06, 07, 14, 1C, 2A, 72 and 88. The resulting arrangement of data unit values is matched, one per one, with the data unit values in the table, producing an inverse index for decoding coded segments. The inverse index is constructed on a read operation from the translation scheme that is attached to each coded segment. For clarity, the construction with the table in FIG. 6B is used as the inverse offset table where n=3 is used to exemplify.

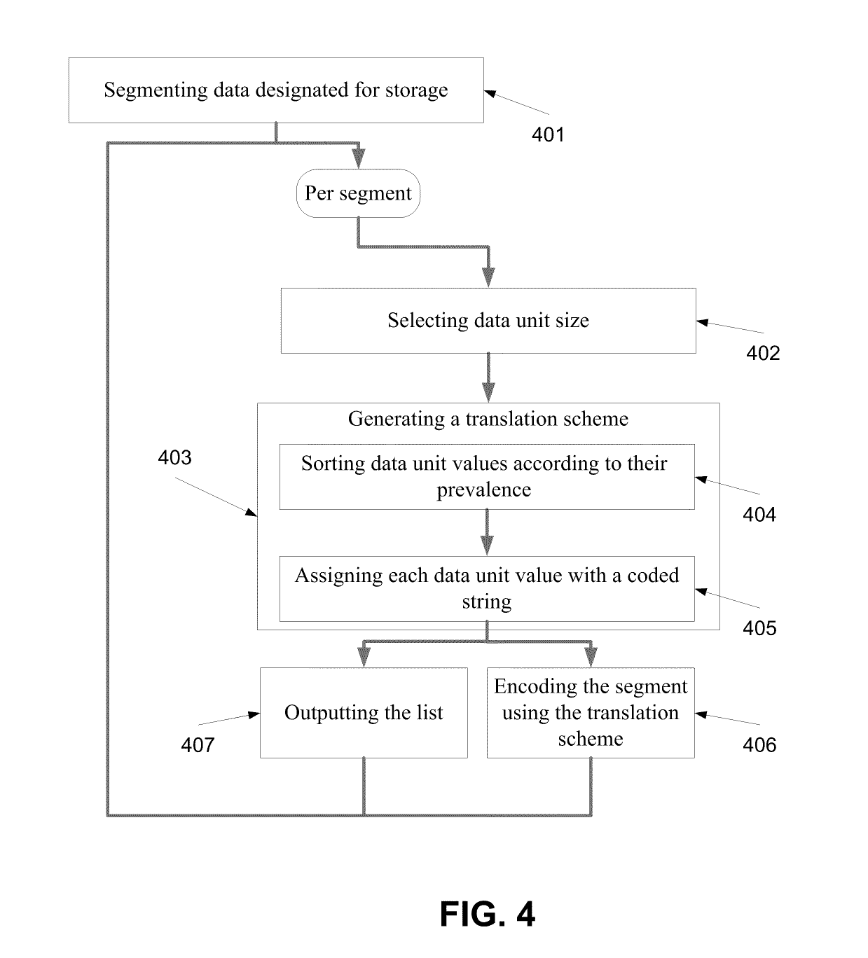

Reference is now made to FIG. 4, which is a flowchart of an exemplary process for encoding input data according to the prevalence of data unit values, according to some embodiments of the present invention. First, as shown at 401, the input data is segmented to a plurality of segments, for example as described above. Then, in each segment, as shown at 402, a k-bit length of the input data units is selected, optionally automatically, in advance, and/or according to an analysis of the received data and/or the respective segment. Now, as shown at 403, a translation list is generated. Optionally, as shown at 404, the available k-bit values of the input data units in all the segments are ordered in a decreasing or increasing order according to their prevalence and/or frequency. Now, as shown at 405, each value in the list is associated or assigned with a m-bit value where m≧k. Optionally, the most prevalent data unit value is assigned with an coded string that induces the lowest wear factor when written and the following data unit values in the list are sequentially assigned with coded strings in an increasing wear factor order.

Now, as shown at 406, the translation list is used for encoding the segments of the data designated for being written. As shown at 407, the list is outputted to allow programming the memory cells to store the list.

Reference is now made, once again, to FIG. 2. After the input segments are encoded, as shown at 204, for example as described above, they are written in the memory element 106. As shown at 205, the translation scheme, for example the translation list outputted in block 407 of FIG. 4, may be also stored in the memory element 106. The encoded data may be decoded when a request for access it is received from the host 101, for example from a file system and/or an application.

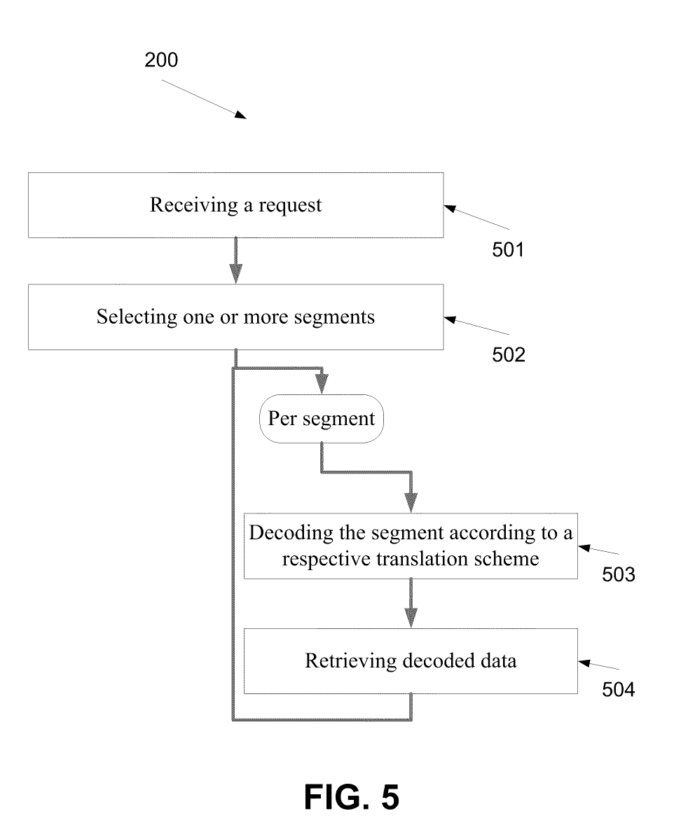

Reference is now made to FIG. 5, which is a flowchart for decoding the encoded data according to a translation scheme, such as a translation list, for example the translation list created as depicted in FIG. 4, according to some embodiments of the present invention. First, as shown at 501, a request to read some or all of the stored data is received, for example from a file system and/or an application hosted by the host 101. As shown at 502, if the read request is related only to a portion of the stored data, the relevant encoded segment as found, for example using known data access methods.

Then, for each one of the requested segments, as shown at 503, the translation scheme, such as a translation list, which is related to the requested segments, is used for translating the coded strings to respective input data units. Each segment optionally contains the related translation list or a link thereto.

Optionally, an inverse index, which is created according to the translation scheme, is used for decoding the coded data. Optionally, the following is performed:
1. Set x←0.
2. The translation scheme is scanned, one n bits at a time:
   a. Index an inverse offset table, from which offset values are read, according to the next n bits from the translation scheme. For example, the combination 011 is based on the next 3 bits in the translation scheme, looking at FIG. 6B, offset 9 is assigned.
   b. The offset is used to index a data unit value, for example assume that at offset 9 the translation table contains the m bit data unit 1100111101.
   c. Increment the offset in the inverse offset table. For example, the offset of the representation 011 is incremented from 9 to 10.
   d. Assign this data unit value to a value x in the inverse table. For example the value x is written in the position whose binary index is 1100111101 in the inverse code.
3. Proceed to the next n bit entry in the translation scheme. Increment x. If there are no more entries, terminate else, continue at step 2.

In such embodiments, where x=2^{k}, all data unit values that are in the table have been assigned with a coded string. When m>k, the other data unit values are unused and not referred to if the coded data is faithfully recorded. A reference to an unassigned value may be used as an additional error detection mechanism.

Now, the translated data is retrieved to the host 101, as shown at 504, for example to the file system and/or application.

According to some embodiments of the present invention, the memory element 106 includes memory cells with more than two states, for example MLC flash memory elements. For example, a 2-bit MLC memory element has an erased state that is indicative of the value ‘11’ and three programmed respectively indicative of ‘01’, ‘10’ and ‘00’, which differs by their voltage threshold level (Vt). The assignment of bit values to MLC levels is arbitrary, but assigning ‘11’ to the erased state is customary. Regarding the programmed states, some MLC vendors assign the values 10, 01, and 00 to increasing Vt levels, while others arrange them in another order, for example 10, 00, and 01. In this application, without loss of generality, 00 is assumed to be the programmed state with highest Vt; however it may be another state. The wear experienced by a cell during programming is approximately proportional to its Vt level. Cells that are erased without being programmed experience essentially no wear.

In order to evaluate the wear factor of each data unit, different states are weighted according to the wear they induce. The wear factor is calculated as the sum of the weights. By assigning data units with a wear factor, a translation scheme may be generated for encoding the input data in a similar manner to the described in FIG. 4. Optionally, a translation list is created based on the estimated wear of different memory cell states. For example, FIG. 9 depicts a table that assigns different wear factors to different states, proportionally to the estimated wear they induce when represented in an MLC cell. In such a manner, the prevalence of one or more memory cell states which induce less wear is increased in relation to one or more other memory cell states which induce more wear.

In such embodiments memory cell states manifested by high voltage are replaced with memory cell states manifested by low or no voltage. For example, when the memory cells 107 are 4 state MLC memory cells, the prevalence of high voltage states, such as 00, may be reduced in relation to the prevalence of lower voltage states, for example 11.

Similarly to the described in relation to FIG. 2 above, input data is segmented and each segment is encoded by converting its input data units to coded strings so as to reduce the total wear factor thereof. The decoding is performed similarly to the described above. Optionally, if the memory element is a 2 bit MLC memory element, m is a multiple of 2 so that a coded word may be written as an integral number.

According to some embodiments of the present invention, the size of the translation scheme, which is used for encoding the input data units, is reduced before being stored in the memory element 106.

Optionally, the translation scheme allow decoding and encoding input data units with a similar wear factor by assigned each one of them with a common m-bit value. For example, when the input data units and the codes strings are byte long (k=m=8), and the wear factor of the coded strings ranges between 0 and 8, 4 bit values are assigned for representing the coded strings used in the encoded segment. In such a manner 128 bytes are needed for the translation scheme (4 bits for each of one of the 256 values). In this example, the 4 bits representation indicates which coded string is assigned to which input data unit. The value of a coded string of a certain wear factor is assigned to a certain value of an input data unit according to the order of the certain value of the input data unit appearance in the input segment in relation to other values with the same wear factor.

For example, the scheme translation may be generated by the following process. First, a table of 2^{k} coded strings is generated out of the data unit values with the lowest wear factor of the possible 2^{m} data unit values and arranged in ascending order (according to their wear factor).

Then, the number of data unit values in each wear factor category is counted, for example as shown in FIG. 6A where k=m=8 and the wear factor categories and counts are arranged for example as shown at FIG. 6A. Each wear factor category in the table is assigned with a coded string. If the number of wear factor categories is less than 2ⁿ and more than 2ⁿ⁻¹, n bits are sufficient to represent all the wear factor categories. For example, if there are 6 wear factor categories, 3 bits are necessary as n=3. Optionally, if the number of wear factor categories slightly exceeds the nearest power of 2, several of the least frequent wear factor categories may optionally be rolled together into a single category to cut the number of categories in the category table down to this nearest power, saving a bit in the representation. For example, as shown in FIG. 6A, there were originally 9 wear factor categories and apparently needing n=4. However, by rolling together the wear factor categories 7 and 8, n=3 is sufficient. For example, when decoding, the 4 bits representation indicates the wear factor of the possible input data unit value and the location of the 4 bits representation in the ordered list indicates to which value of the values with the common wear factor the coded string is assigned. For instance, the translation scheme assigns the representation binary 0111 to a value of an input data unit having wear factor=7, the decoding thereof is determined according to its appearance order in the input segment, for example in the following order hex 01, 02, 04, 08, 10, 20, 40, 80.

Each wear factor category, which may be a wear factor category that unifies a number of factor categories, similarly to the described above, is assigned with a unique n bit representation so that the most frequent wear factor category in the table is assigned with an n bit coded string that has the lowest wear factor, and the remaining wear factor categories are assigned higher n bit coded strings, in the order of their frequency in the table.

The translation scheme is then of size n×2^{k} bits where n bits are used for each possible k-bit coded string. Optionally, an inverse offset table is prepared for decoding the coded segment. It is indexed by the n bit values of wear factor categories. As an example for SLC where k=m=8 and n=3 see FIG. 6B that depicts a table derived from the table depicted in FIG. 6A as follows: An initial offset value is the offset of the first offset of a particular wear factor category in the table, for example the table shown in FIG. 6A. The table's entries are sorted by the n bit coded strings, as exemplified in FIG. 6B, to allow direct indexing by an n bit value.

The inverse offset table is used for performing read and/or write operations, for example as described above.

Optionally, the translation scheme maps 256 different data unit values by assigning a common 3 bit value to data unit values with a common wear factor. In such an embodiment, one of the 3 bit values represents two different wear factors, for example the binary value ‘111’ represents both 7 and 8. This means that the only coded string with the wear factor 8, namely hex 00 is represented by the same 3 bit value as the wear factor 7 coded strings, namely hex 01, 02, 04, 08, 10, 20, 40, and 80. This may cause input data units to be assigned in non-optimal order, however, since these 9 code words by definition represent the least frequent input data units in the data, the loss is negligible. With 3 bits instead of 4 bits, the total representation size is 96 bytes (3 bits for each of 2⁸ values).

Additionally or alternatively, the wear factor of the translation scheme is reduced to decrease the wear caused by the storage operations. Values of input data units with high wear factor and/or high frequency in the translation scheme are encoded using values with a smaller wear factor. For example, the least-wear factor 3-bit value, binary ‘111’, is used for encoding the input data unit with the most common wear factor, for example, as shown in FIG. 6A. The translation scheme defined by table 1 has 96 byte with a total wear factor of 233, namely an average wear factor of 2.4 per byte.

According to some embodiments of the present invention, the size of some or all of the plurality of segments is adjusted according to the size of the coded strings and/or the translation scheme.

Translation scheme may be separately stored in each segment, together with the coded data. In such an embodiment, a portion of the segment is allocated for the translation scheme. In this case, the size of a segment read or written may be referred to herein as the coded segment size.

Optionally, the translation scheme is stored in the out of band bytes (OOB) of the memory element 106. For example, if the memory element 106 includes NAND pages, such as 4 KB and 8 KB pages, it consists, per page, a number of OOB, for example 128 and 256, that may be used. The OOB may be used for marking an erase block as bad, storing error correction codes (ECC), and storing file system specific information (JFFS2). Optionally, the wear reduction coder 110 verifies the availability of the OOB before using it for storing the translation scheme. In such embodiments, the portion of the coded data in each segment is smaller than the page size, for example 4000 bytes or 8000 bytes, in a way that leaves space for storing the code representation in the page area and/or in the OOB portion.

Optionally, a number of segments are stored in each page. A smaller segment size has the advantage of producing an adaptive code better suited for the data, and so of achieving better wear reduction. It should be noted that beyond a certain point no further improvement is resulted. It should further be noticed that if each segment has a unique translation scheme, the space overhead is increased.

Optionally, the size of some or all of the segments written in the memory element 106 is larger than a page. In such embodiments the segment is divided over a number of pages. Such segments have lower overhead as a single copy of the translation scheme is used for translating data stored in a number of pages. However, the wear reduction may decrease as the variety of values that has to be documented increases so that coded strings with relatively high wear factor and/or size have to be used.

It should be noted that using the encoding processes described above may be used to increase the write speed of a memory device. For example, the number of memory cells that have to written is reduced as the erased memory cell represents the memory cell state which the prevalence thereof is increased.

In addition, in both MLC and SLC, the programming of the memory cells involves more low level voltage charges and less high level voltage charges. This reduces the number of write pulses which are needed to be applied and therefore reduces the write time.

Optionally, the encoding processes described above may be used to reduce the power consumption of a memory device. The reduction in the number and length of write pulses, as described above, reduces the power consumed by the memory device for writing operations.

Optionally, the encoding processes described above may be used to reduce the write-disturb fault (WDF) of a memory device. As described above, the level of the voltage charges which are applied is reduced. WDF are induced when a field of one cell overlaps adjacent cells, leading to potential false writes. As the average voltage used is lower, the probability of WDF is reduced.

Optionally, the encoding processes described above may be used to increase the data retention of a memory device. Data retention in flash memory devices, such as 106, is limited by the slow degradation of voltage levels in cells due to leakage. Since erased cells are immune to this phenomenon, and since higher voltage levels degrade faster, the aforementioned encoding processes improve data retention.

Optionally, the encoding processes described above may be used to decrease cross-charge effects in the memory device. Some flash technologies, such as NROM, carry two separate charges per cell. Distortions caused by cross-charge effects within a cell are a major source of data errors for such flash. When using one of the aforementioned encoding processes, the data is encoded so that charge value pairs causing the most cross-charge disturbance are least frequent.

Reference is now made to a description of an exemplary process for encoding data so as to reduce prevalence of ‘0’ bits in data stored in SLC memory elements.

In this example, input data units of 4-bit length are encoded by coded strings having 6-bit length so that k=4 and m=6. The SLC memory element is a NAND flash memory having a NAND page size of 4096 (+128) bytes with 4050 data bytes. The size of the exemplary segment is 2700 bytes (2700×6/4=4050) so that each segment contains 5400 “words”. For example, as shown at FIG. 7, 16 possible 4-bit data words are used for mapping the possible input data units in each segment. Assume, for a particular segment, that frequencies were tabulated as shown in FIG. 7.

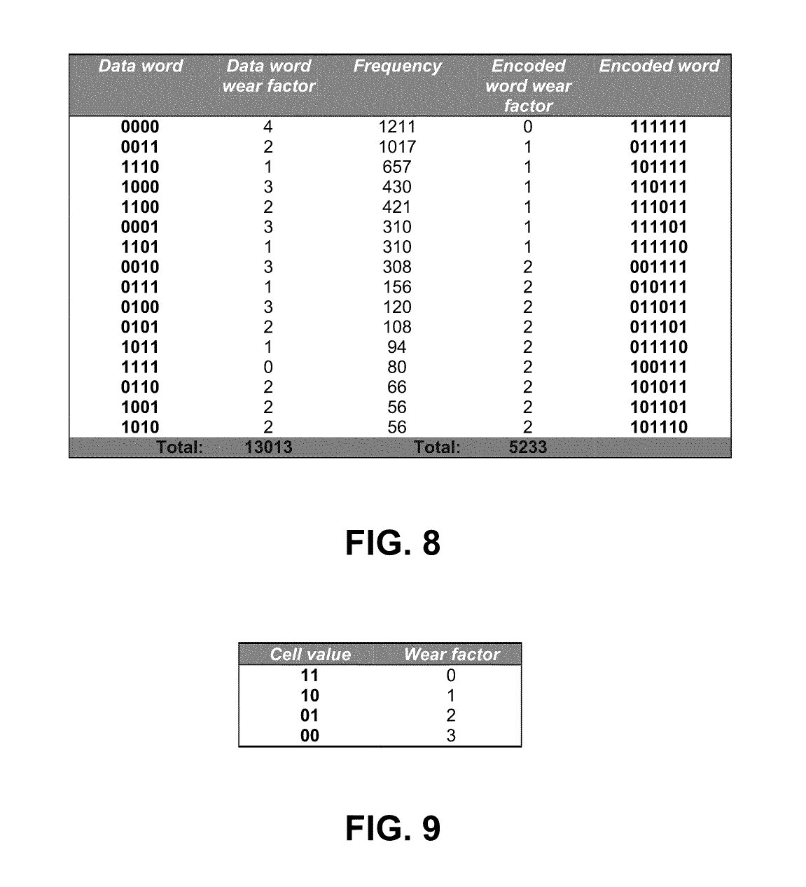

Optionally, as shown at FIG. 8, translation scheme is generated for the particular segment by sorting the input data units, the 4 bit words, in a decreasing order of frequencies and assigning each one of the a 6-bit coded string from a respective list of 6-bit coded strings ascendingly ordered according to their wear factors. The table shown at FIG. 8 indicates that while the total number of ‘0’ bits in the input data of the particular segment is 13013, the portion of the ‘0’ bits in the encoded segment is 40% therefrom, namely 5233. Wear is reduced by a factor of 13013/5233*6/4=3.73.

Reference is now made to a description of an exemplary process for encoding data so as to reduce prevalence of one or more memory cell states in relation to one or more others by encoding data designated to be stored in MLC memory elements.

The input data and the particular segment are as described in the previous example. The frequencies of input data units in the particular segment are as shown at FIG. 7. Similarly, input data units of 4-bit length are encoded by coded strings having 6-bit length so that k=4 and m=6.

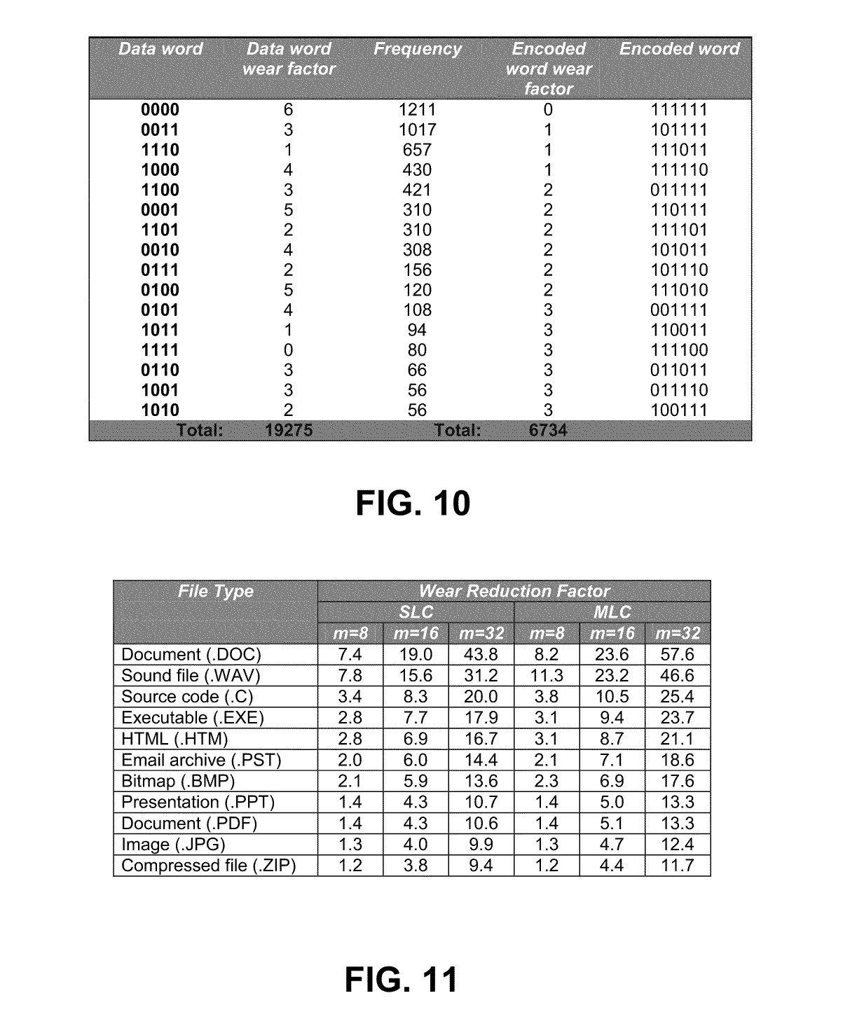

Optionally, as shown at FIG. 10 and in a similar manner to the described above, a translation scheme is generated for the particular segment. The generation includes sorting the input data units, the 4 bit words, in a decreasing order of frequencies and assigning each one of the a 6-bit coded string from a respective list of 6-bit coded strings ascendingly ordered according to their wear factors.

The table shown at FIG. 10 indicates that while the total wear factor in the particular segment is 19275, the portion of the wear factor of the encoded segment is 35% therefrom, namely 6734. Wear is reduced by a factor of 19275/6734*6/4=4.29.

As described above, the data which is designated to be written is segmented before being encoded. According to some embodiments of the present invention, the size of each segment is selected in advance, optionally according to an analysis of the original data.

It is expected that during the life of a patent maturing from this application many relevant systems and methods will be developed and the scope of the term a memory element, a memory cell, and translation scheme is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Reference is now made to the following example, which together with the above descriptions, illustrates some embodiments of the invention in a non limiting fashion.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

In this example, the methods described above were implemented and run on several representative files. Throughout, bytes were used as input data units, for example k=8, and the size of each encoded segment is 4000 bytes. Wear reduction was projected for 6 scenarios:
1. SLC
   a. byte coded word long strings (m=8)
   b. 2-byte coded word long strings (m=16)
   c. 4-byte coded word long strings (m=32)
2. MLC
   a. byte coded word long strings (m=8)
   b. 2-byte coded word long strings (m=16)
   c. 4-byte coded word long strings (m=32)

The results, not including the wear of the translation scheme, are presented in the table depicted in FIG. 11.

Various embodiments and aspects of the present invention as delineated hereinabove and as claimed in the claims section below find experimental support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of encoding and storing data, comprising:
providing digital data designated to be written in at least one memory element having a plurality of memory cells;
encoding digital data so as to increase the prevalence of at least one memory cell state in relation to the prevalence of at least one other memory cell state; and
programming said plurality of memory cells to store said encoded digital data.

2. The method of claim 1, wherein said encoding increases the prevalence of said at least one memory cell state in relation to the prevalence of at least one other memory cell state in at least 25%.

3. The method of claim 1, wherein said encoding comprises calculating a wear factor induced from storing each of a plurality of data units of at least one segment of said digital data in said at least one memory element and encoding said at least one segment according to said wear factor.

4. The method of claim 3, wherein said calculating comprises calculating said wear factor by weighting at least one memory cell state in said respective data unit according to the voltage threshold level (Vt) used by said plurality of memory cells for the representation thereof.

5. The method of claim 1, wherein further comprising computing a translation scheme according to an analysis of said digital data, said encoding being performed according to said translation scheme, said programming comprises programming said at least one memory element to store said translation scheme.

6. The method of claim 5, said programming comprises programming said at least one memory element to store at least a portion of said translation scheme in out of band bytes (OOB) of its pages.

7. The method of claim 5, wherein said translation scheme comprises a translation list having a plurality of values of a plurality of data units in said digital data, each said data unit being assigned with an coded string according to the prevalence thereof in at least at least one segment of said digital data.

8. The method of claim 7, wherein said translation scheme is compressed according to the order of said plurality of values, said order being set according to the frequency of said plurality of values in said digital data.

9. The method of claim 1, wherein said programming requires more memory space than programming said plurality of memory cells to store said digital data.

10. The method of claim 1, further comprising segmenting said digital data to create a plurality of segments, said encoding comprising separately encoding each said segment so as to increase the prevalence of at least one memory cell state in relation to the prevalence of at least one other memory cell state in a respective said segment.

11. The method of claim 10, wherein each said segment is a k-bit string, said encoding being performed by using m-bit strings to encode said plurality of segments, where m>k and said m-bit strings being the 2^{k} m-bit strings with least wear factor.

12. The method of claim 10, wherein said memory cell states are binary states, said encoding comprises inverting the binary value of each said segment if the prevalence of said at least one other memory cell state being higher than the prevalence of said at least one memory cell state in said respective segment.

13. The method of claim 1, further comprising compressing said digital data before said encoding.

14. A memory device, comprising:
at least one memory element having a plurality of erasable and re-programmable non-volatile memory cells;
an input interface which receives digital data from a host;
a wear reduction coder which encodes said digital data so as to increase the prevalence of at least one memory cell state in relation to the prevalence of at least one other memory cell state; and
a memory controller which programs said plurality of memory cells to store said encoded data.

15. The memory device of claim 14, wherein said memory controller segments said digital data to a plurality of segments and said wear reduction coder encodes each said segment so as to increase the prevalence of said at least one memory cell state in relation to the prevalence of said at least one other memory cell state, said memory controller programs said plurality of memory cells to store said plurality of encoded segments.

16. The memory device of claim 14, wherein said at least one memory cell state is the memory cell state ‘1’ and said at least one other memory cell state being the memory cell state ‘0’.

17. The memory device of claim 14, wherein said wear reduction coder creates translation scheme, said wear reduction coder encodes said digital data according to said translation scheme.

18. The memory device of claim 14, wherein said at least one memory element includes a multi level cell (MLC) memory element, said wear reduction coder encodes said digital data so as to increase the prevalence of a plurality of memory cell states in relation to the prevalence of a plurality of other memory cell states.

19. The memory device of claim 18, wherein at least some of said plurality of said other memory cell states is represented by at least one first voltage threshold level (Vt) at said volatile memory cells and at least some of said plurality of said memory cell states being represented by at least one second Vt at said volatile memory cells, said at least one first Vt being higher than said at least one second Vt.

20. The memory device of claim 14, wherein the size of each said encoded segment is larger than the size of a page of said at least one memory element.

21. The memory device of claim 14, wherein the size of each said encoded segment is smaller than the size of a page of said at least one memory element.

22. The memory device of claim 14, wherein said at least one memory element comprises a flash memory.

23. A system of storing encoded data, comprising:
a host which provides digital data for storage;
a wear reduction coder which encodes said digital data so as to increase the prevalence of at least one memory cell state in relation to the prevalence of at least one other memory cell state plurality in said digital data; and
a memory device having at least one memory element with a plurality of erasable and re-programmable non-volatile memory cells and a memory controller which programs said plurality of memory cells to store said encoded data.

24. The system if claim 23, wherein said wear reduction coder is hosted by said host.

25. The system if claim 23, wherein said wear reduction coder is a firmware module integrated said memory controller.

26. A method of decoding stored data, comprising:
providing request for digital data stored in at least one memory element having a plurality of memory cells;
identifying a translation scheme for decoding at least one segment of said digital data in said at least one memory element;
decoding digital data using said translation scheme; and
retrieving said decoded digital data;
wherein said decoding increases the prevalence of at least one memory cell state in relation to the prevalence of at least one other memory cell state in said at least one segment.

27. A method of encoding and storing data, comprising:
providing digital data designated to be written in at least one memory element having a plurality of memory cells;
encoding digital data so as to reduce the prevalence of at least one memory cell state; and
programming said plurality of memory cells to store said encoded digital data;
wherein the size of said encoded digital data is not smaller than the size of said digital data.
